(19) United States
(12) Patent Application Publication
(10) Pub. No.: US 2007/0277002 A1
(43) Pub. Date: Nov. 29, 2007

(54) APPARATUS FOR SHARING ACCESS BY TWO MODULES AND METHOD THEREOF

(76) Inventors: Keng-Hsiang Liao, Taipei County (TW); Cheng-Hsin Chang, Hsinchu City (TW); Yi-Chih Huang, Hsin-Chu City (TW); Yu-Ting Chuang, Kao-Hsiung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/749,737

(22) Filed: May 16, 2007

(30) Foreign Application Priority Data
May 16, 2007 (TW) 096117412
May 16, 2006 (TW) 095117218

(51) Int. Cl. G06F 13/28

(52) U.S. Cl. 711/147

(57) ABSTRACT

The present invention discloses an apparatus for sharing access by two modules includes at least a storage unit, a first module, and a second module. The second module is coupled to the first module and the storage unit, for accessing the storage unit according to a transmission protocol. The first module accesses the storage unit through the second module according to the transmission protocol. The present invention allows the first module to share access to the storage unit with the second module and thus the first module no longer needs to connect to another storage unit.

### FIELD OF THE INVENTION

The present invention relates to an apparatus and a method for sharing access by two modules, and more particularly to an apparatus and a method for sharing a storage unit by two modules and method thereof that allow a module to share the storage unit with another module, so that the first module no longer needs to connect to another memory storage unit.

### BACKGROUND OF THE INVENTION

Referring to FIG. 1, a general DVD player 500 includes a main control chip 100 (such as a control servo) and a video processor 200 (such as a video decoder), and the main control chip 100 has an auto gain control function and an error correcting control function for maintaining the clearness of the audio and video source. The video processor 200 has a MPEG decoding function and an image post-processing function for converting a plurality of raw data and the format of processing data. For the conventional operations of the main control chip 100 and the video processor 200, it is necessary to connect at least a memory 300 (such as a flash memory) and a buffer 400 (such as a DDR memory), and the memory 300 is provided for recording a booting program and a data variable, and the buffer 400 is provided for storing the raw data and the processed data. The main control chip 100 stores the raw data and processed data into the buffer 400 first; and after the video processor 200 loads the data, the main control chip 100 stores the raw data and processed data into the buffer 400 of the video processor 200, so that the main control chip 100 and the video processor 200 can output the multimedia audio/video data successfully.

However, the memory 300 comes with at least 20 pins, and the buffer 400 comes with at least 40 pins, and thus there are more than 60 pins that the memory 300 and the buffer 400 are connected respectively to the main control chip 100 and the video processor 200. Furthermore, the number of pins used for other functions of the memory 300 and the buffer 400 is amazingly large, and which causes cross talk effect, electrical magnetic interference, and limitations to layout on circuit boards. The volume of the main control chip 100 and the video processor 200 having so many pins will be very large, and thus the volume of the DVD player 500 that contains the large main control chip 100 and video processor 200 will become larger when a memory 300 and a buffer 400 are installed. As a result, the volume and the cost of the DVD player 500 cannot be reduced effectively by decreasing the size of the external memories connected to the chip.

### SUMMARY OF THE INVENTION

In view of the shortcomings of the complicated circuit layout of the aforementioned chips and the ineffectiveness of expediting the circuit design, it is a primary objective of the present invention to provide an apparatus for sharing access by two modules includes at least a storage unit, a first module, and a second module. The second module is coupled to the first module and the storage unit, for accessing the storage unit according to a transmission protocol. The first module accesses the storage unit through the second module according to the transmission protocol.

Another objective of the present invention is to provide a method for sharing accessing by two modules, comprising sending a first request signal by a first module to a second module; receiving the first request signal by the second module; accessing a storage unit for first data according to a transmission protocol by the second module; sending the first data by the second module to the first module according to the transmission protocol; and receiving the first data by the first module.

The above and other objects, features and advantages of the present invention will become apparent from the following detailed description taken with the accompanying drawings.

### BRIEF DESCRIPTION OF THE DRAWINGS

FIG. 1 is a schematic block diagram of a main control chip coupled to a video processor according to a prior art;

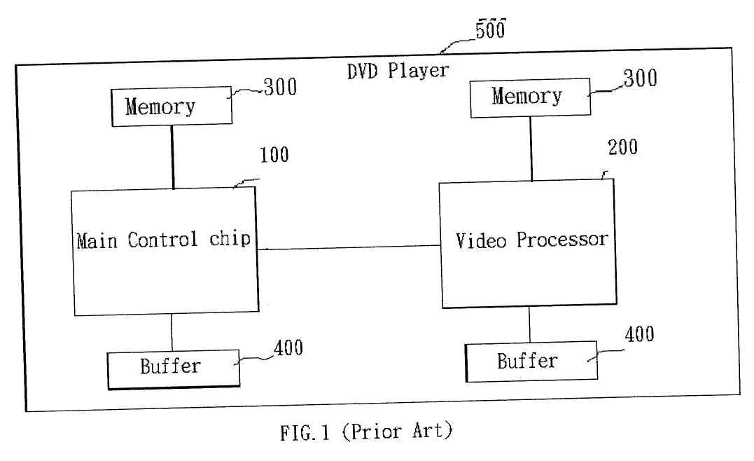

FIG. 2 is a schematic block diagram of an apparatus for sharing a storage unit by two modules of the present invention;

FIG. 3 is a flow chart of a method for sharing a storage unit by two modules of the present invention;

FIG. 4 is a flow chart of a method as depicted in FIG. 3 according to an embodiment of the present invention;

FIG. 5 is a flow chart of a method as depicted in FIG. 3 according to another embodiment of the present invention;

FIG. 6 is a flow chart of reading an executable program from a memory storage unit according to a embodiment of the present invention;

FIG. 7 is a flow chart of booting a first module according to an embodiment of the present invention; and

FIG. 8 is a flow chart of booting a first module according to a embodiment of the present invention.

### DETAILED DESCRIPTION OF THE EMBODIMENTS

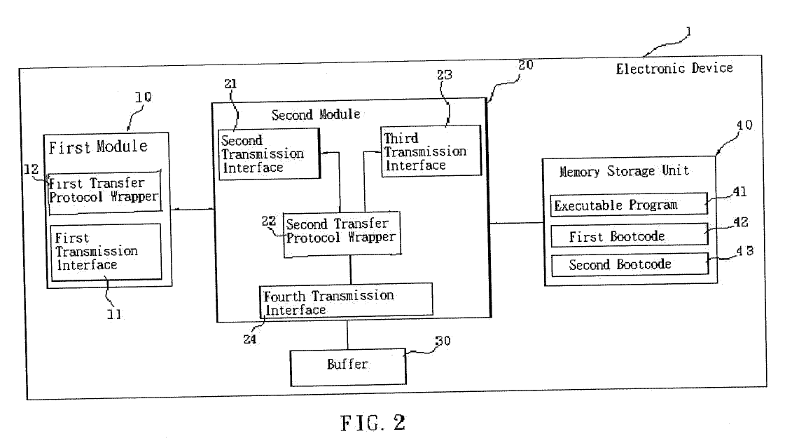

Referring to FIG. 2 for an apparatus for sharing a storage unit by two modules in accordance with the present invention, the apparatus includes a first module 10 (such as an active chip) and a second module 20 (such as a passive chip), both installed in an electronic device 1 (such as a DVD player). The first module 10 includes a first transmission interface 11, and the second module 20 includes a second transmission interface 21 connected to the first transmission interface 11, such that the first module 10 can access data with the second module 20 through the first transmission interface 11 and the second transmission interface 21, and the second module 20 can access data with the first module 10 through the first transmission interface 11 and the second transmission interface 21.

In FIG. 2, the second module 20 is coupled to a non-volatile memory storage unit 40 (such as a flash memory), and the memory storage unit 40 includes a plurality of executable programs 41 (such as a video recoding program and a playback program), a first bootcode 42 and a second bootcode 43. The first bootcode 42 is provided for booting the first module 10, and the second bootcode 43 is provided for booting each second module 20. The first module 10 reads the plurality of executable programs 41 stored in the memory storage unit 40 through the second module 20, where the plurality of executable programs 41 are mostly firmware to be utilized and executed by the first module 10. The executable programs 41 can be stored in the memory storage unit 40 when the electronic device 1 is turned off, so as to facilitate the first module 10 to read the executable programs 41 through the second module 20 when the electronic device 1 is rebooted. In addition, the second module 20 can also reads the plurality of executable programs 41 stored in the memory storage unit 40. In one embodiment of the present invention, the first module 10 and the second module 20 have respectively corresponding executable programs 41, to be accessed by the modules respectively.

In FIG. 2, the second module 20 further includes a third transmission interface 23 disposed at a position corresponding to the memory storage unit 40 for processing the first bootcode 42 to be utilized by the first module 10 and the second bootcode 43 to be utilized by the second module 20 both read from memory storage unit 40 or accessing the executable programs 41. If the first module 10 and the second module 20 operate, the first module 10 can request the second module 20 to obtain the first bootcode 42 from the memory storage unit 40 through the first transmission interface 11 and the second transmission interface 21 to boot the first module 10. The second module 20 also can obtain the second bootcode 43 from the memory storage unit 40 to boot the second module 20. Therefore, the present invention allows the first module 10 to share the memory storage unit 40 of the second module 20, and thus the first module 10 no longer needs to be connected to other memory storage unit, so as to simplify the use of resources in the electronic device 1 and lower the material cost.

In FIG. 2, the second module 20 is coupled to a volatile buffer 30 (such as a DDR memory), and the second module 20 includes a fourth transmission interface 24 disposed at a position corresponding to the buffer 30 for controlling the data access with each buffer 30. After the first module 10 receives and processes an external source data to produce first data, the first module 10 can access the first data with the buffer 30 through the second module 20, and the first module 10 can also send the first data to the second module 20 through the second transmission interface 21 directly for data processing. When the second module 20 processes the received first data, the second module 20 can access the buffer 30.

In a embodiment of the present invention, the electronic device 1 is a DVD player; the first module 10 could be a servo chip (Servo); the second module 20 could be a multimedia chip (Video Decoder); the memory storage unit 40 could be a flash memory (Flash); and the buffer 30 could be a dynamic random access memory (DRAM). After the DVD player receives an optical disk data, the servo chip starts processing the content of the optical disk data and converts the optical data into the first data (such as a data stream), and the servo chip sends the first data to the multimedia chip and the multimedia chip sends the first data to the dynamic random access memory for the processing the first data later. In the meantime, the multimedia chip can receive the first data from the servo chip and decompress the first data, so that the optical disk data can be converted into digital data for the use by the DVD player.

When the first module 10 transmits signals or data to the second module 20 as shown in FIG. 2, the data standard of the first module 10 is different from that of the second module 20, and thus the second module 20 cannot process the signal or data transmitted from the first module 10. As a result, the first transmission interface 11 and second transmission interface 21 must jointly follow a transmission protocol that allows the first module 10 and second module 20 to be able to receive, process, and send their signals, data, or responding data. In the present invention, the first module 10 includes a first transfer protocol wrapper 12, and the second module 20 includes a second transfer protocol wrapper 22, and the first transfer protocol wrapper 12 is coupled to the first transmission interface 11, such that the first module 10 conforms to the transmission protocol for accessing data with the second module 20, and the second transfer protocol wrapper 22 is coupled separately to the second, third and fourth transmission interfaces 21, 23, 24, such that the second module 20 conforms to the transmission protocol for accessing data with the first module 10.

In this embodiment, the first module 10 sends out a boot signal that conforms to the transmission protocol by the first transfer protocol wrapper 12 to the second module 20 through the first transmission interface 11. After the second module 20 obtains the boot signal through the second transmission interface 21, the second module 20 reads the second bootcode 43 by the second transfer protocol wrapper 22 through the third transmission interface 23 to boot the second module 20, and the second module 20 reads the first bootcode 42 through the third transmission interface 23 to boot the first module 10 and start performing the job.

After the first module 10 converts the source data into the first data as shown in FIG. 2, the first module 10 requests the second module 20 to store the first data into the buffer 30 through the fourth transmission interface 24 or store the first bootcode 42 into the memory storage unit 40 through the third transmission interface 23, such that the bootcode can be read when it is needed. When the second module 20 is booted, the first data stored in the buffer 30 is read through the fourth transmission interface 24. After the first data is processed, the first data is saved into the buffer 30 or read out from the buffer 30.

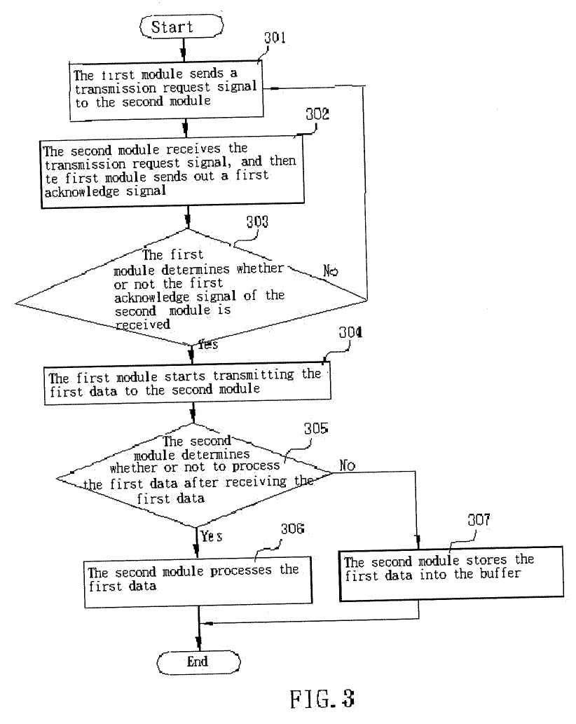

A method for sharing a storage unit by two modules is also disclosed in a embodiment of the present invention as shown in FIG. 2. When the first module 10 requests the second module 20 to receive the first data, and the first data is saved into the buffer 30 as shown in FIG. 3, the first module 10 and second module 20 process the following steps:

(Step 301) The first module 10 sends a transmission request signal to the second module 20;

(Step 302) The second module 20 receives the transmission request signal, and then the first module 10 sends out a first acknowledge signal;

(Step 303) The first module 10 determines whether or not the first acknowledge signal of the second module 20 is received; if yes, perform Step 304, or else perform Step 301;

(Step 304) The first module 10 starts transmitting the first data to the second module 20;

(Step 305) The second module 20 determines whether or not to process the first data after receiving the first data; if yes, perform Step 306, or else perform Step 307;

(Step 306) The second module 20 processes the first data; and

(Step 307) The second module 20 saves the first data into the buffer 30.

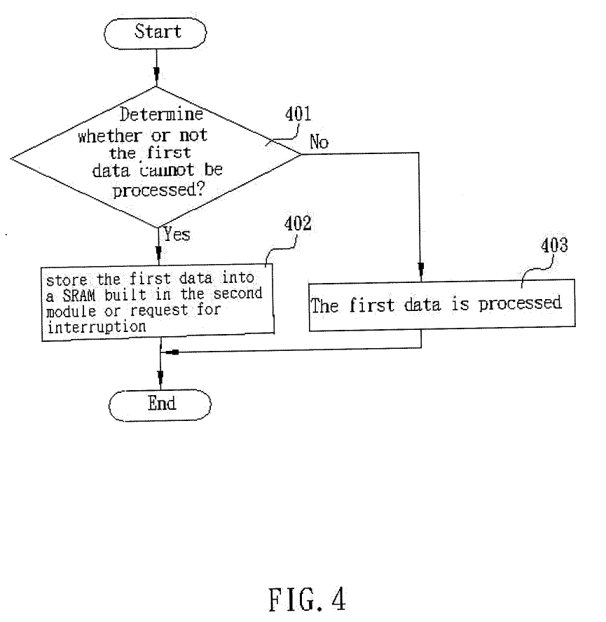

Referring to FIG. 4 for the embodiment of the present invention, the second module 20 processes the first data as follows:

(Step 401) Determine whether or not it is true that the first data cannot be processed; if yes, perform Step 402, or else perform Step 403;

(Step 402) The first data is saved into a static random access memory (not shown) built internally in the second module 20 or request for interruption; and

(Step 403) The first data is processed.

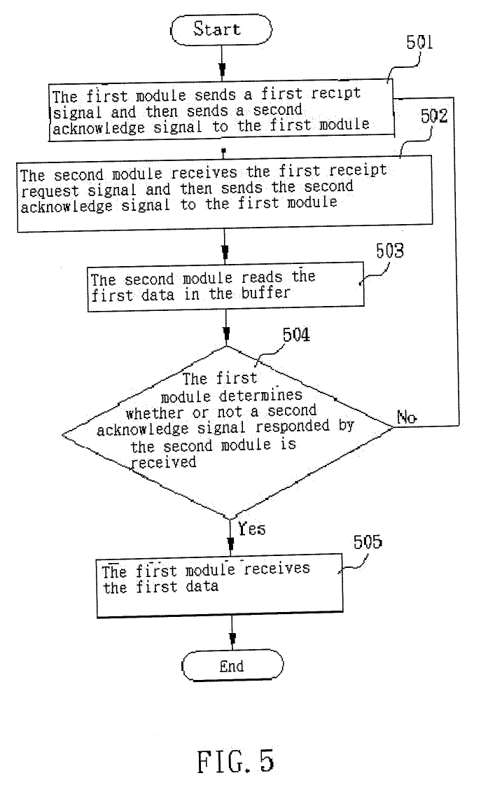

Refer to FIG. 2 for the embodiment again. On the other hand, when the first module 10 reads the first data in the buffer 30 as shown in FIG. 5, the first module 10 and second module 20 process the following steps:

(Step 501) The first module 10 sends a first receipt request signal to the second module 20;

(Step 502) The second module 20 receives the first receipt request signal and then sends out a second acknowledge signal to the first module 10;

(Step 503) The second module 20 reads the first data in the buffer 30;

(Step 504) The first module 10 determines whether or not the second acknowledge signal responded by the second module 20 is received; if yes, perform Step 505, or else perform Step 501; and

(Step 505) The first module 10 starts receiving the first data from the second module 20.

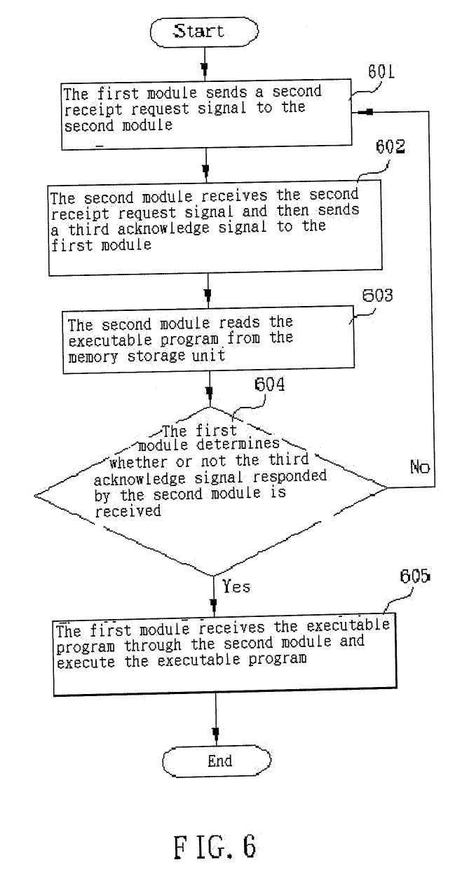

In another embodiment of the present invention as shown in FIG. 2, the memory storage unit 40 stores a plurality of executable programs 41 (such as a video recording program and a playback program). When the first module 10 reads any one of the executable programs 41 in the memory storage unit 40 as shown in FIG. 6, the first module 10 and second module 20 process the following steps:

(Step 601) The first module 10 sends out a second receipt request signal to the second module 20;

(Step 602) The second module 20 receives the second receipt request signal and then sends a third acknowledge signal to the first module 10;

(Step 603) The second module 20 reads the executable program 41 from the memory storage unit 40;

(Step 604) The first module 10 determines whether or not the third acknowledge signal responded by the second module 20 is received; if yes, perform Step 605, or else perform Step 601; and

(Step 605) The first module 10 starts receiving the executable program 41 through the second module 20 and executes the executable program 41.

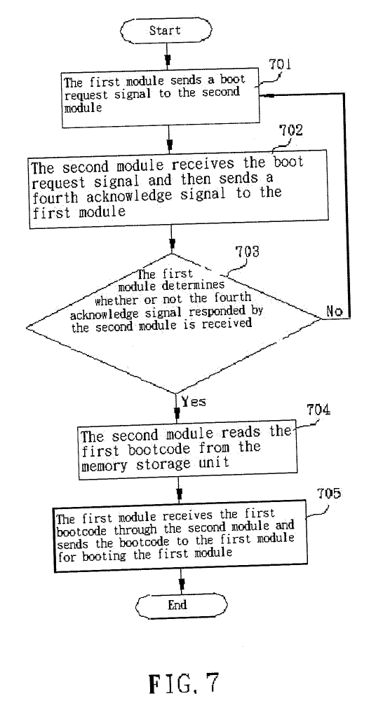

Referring to another embodiment of the present invention as shown in FIG. 2, the memory storage unit 40 further stores a first bootcode 42 capable of booting the first module 10 for booting a second bootcode 43 of the second module 20, such that when the first module 10 reads the first bootcode 42 in the memory storage unit 40 as shown in FIG. 7, the first module 10 and second module 20 perform the following steps: (Step 701) The first module 10 sends a boot request signal to the second module 20; (Step 702) The second module 20 receives the boot request signal and then sends a fourth acknowledge signal to the first module 10;

(Step 703) The first module 10 determines whether or not the fourth acknowledge signal replied by the second module 20 is received; if yes, perform Step 704, or else perform Step 701;

(Step 704) The second module 20 reads the first bootcode 42 from the memory storage unit 40; and

(Step 705) The first module 10 receives the first bootcode 42 through the second module 20 to boot the first module 10.

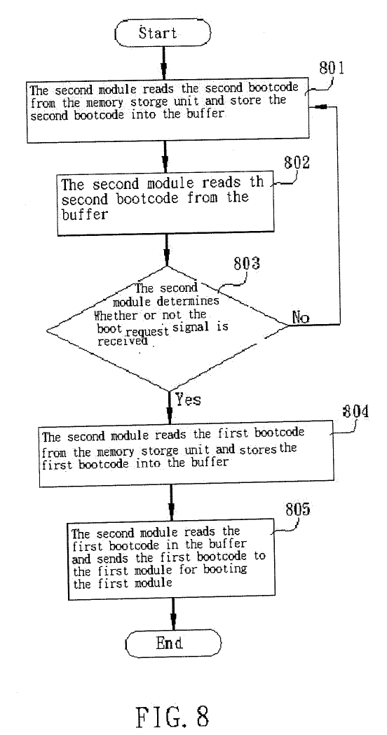

In the embedment as shown in FIG, 2, when the second module 20 boots the first module 10 as shown in FIG. 8, the second module 20 performs the following steps:

(Step 801) The second module 20 reads the second bootcode 43 from the memory storage unit 40 and saves the second bootcode 43 into the buffer 30;

(Step 802) The second module 20 reads the second bootcode 43 in the buffer 30 to boot the second module 20;

(Step 803) The second module 20 determines whether or not the boot request signal is received; if yes, perform Step 804, or else perform Step 801;

(Step 804) The second module 20 reads the first bootcode 42 from the memory storage unit 40 and saves the first bootcode 42 into the buffer 30;

(Step 805) The second module 20 reads the first bootcode 42 in the buffer 30 and sends the first bootcode 42 to the first module 10 for booting the first module 10.

Please note that the scope of the present invention is not limited to the above mentioned embodiments and method steps, and any implementation utilizing different transmission interfaces or transfer protocol wrappers to achieve the goal of sharing one storage unit by at least two modules belongs to the scope of the present invention.

While the invention herein disclosed has been described by means of specific embodiments, numerous modifications and variations could be made thereto by those skilled in the art without departing from the scope and spirit of the invention set forth in the claims.

What is claimed is:

1. An apparatus capable of sharing access by two modules, comprising:
at least a storage unit;
a first module; and
a second module, coupled to the first module and the storage unit, for accessing the storage unit according to a transmission protocol;
wherein the first module accesses the storage unit through the second module according to the transmission protocol.

2. The apparatus of claim 1, wherein the first module comprises a first transmission interface, wherein the first module accesses the storage unit through the first transmission interface and the second module.

3. The apparatus of claim 2, wherein the second module comprises a second transmission interface, coupled to the first transmission interface for transmission between the first and second modules.

4. The apparatus of claim 1, wherein the first module comprises a first transfer protocol, utilized by the first module for transmission between the first and second modules.

5. The apparatus of claim 1, wherein the second module comprises a third transmission interface, wherein the second modules accesses the storage unit through the third transmission interface.

6. The apparatus of claim 1, wherein the second module comprises a second transfer protocol, utilized by the second module for transmission between the first and second modules

7. The apparatus of claim 1, wherein the storage unit is a non-volatile memory device.

8. The apparatus of claim 7, wherein the storage unit comprises a first bootcode for booting the first module and a second bootcode for booting the second module.

9. The apparatus of claim 7, wherein the storage unit comprises a plurality of executable programs.

10. The apparatus of claim 9, wherein the first module accesses and executes the plurality of executable programs.

11. The apparatus of claim 7, wherein the storage unit is a flash memory device.

12. The apparatus of claim 1, wherein the storage unit is a volatile memory device.

13. The apparatus of claim 12, wherein the storage unit is a dynamic random access (DRAM) memory device.

14. A method for sharing accessing, comprising:
sending a first request signal by a first module to a second module;
receiving the first request signal by the second module;
accessing a storage unit for first data according to a transmission protocol by the second module;
sending the first data by the second module to the first module according to the transmission protocol; and
receiving the first data by the first module.

15. The method of claim 14, wherein transmission of the first module conforms to a first transfer protocol.

16. The method of claim 14, wherein the first module sends and receives signals through a first transmission interface.

17. The method of claim 14, wherein transmission of the second module conforms to a second transfer protocol.

18. The method of claim 14, wherein the second module receives the first request signal and sends the first data through a second transmission interface.

19. The method of claim 14, wherein the second module accesses the storage unit through a third transmission interface.

20. The method of claim 19, further comprising:
sending and storing second data to the storage unit by the second module.
